(19) United States
(12) Patent Application Publication
(10) Pub. No.: US 2020/0161021 A1
(43) Pub. Date: May 21, 2020

(54) ELECTRIC WIRE BUNDLING MEMBER AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Hideaki ITO, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/632,961

(22) PCT Filed: Sep. 5, 2018
(86) PCT No.: PCT/JP2018/032864

§ 371 Date: Jan. 22, 2020

(30) Foreign Application Priority Data
Sep. 21, 2017 (JP) 2017-181342

(51) Int. Cl. H01B 7/00; B60R 16/02; H02G 3/30; H01B 13/012; H02G 3/32

(52) U.S. Cl. CPC H01B 7/0045; B60R 16/0215; H02G 3/32; H01B 13/01263; H02G 3/305

(57) ABSTRACT

It is an object of the present invention to make it less likely that an electric wire bundling member that bundles a plurality of wire bundles will be laterally shifted. The electric wire bundling member is a member for bundling a plurality of electric wires. The electric wire bundling member includes: a bundling main body portion formed of an elongated resin member that is deformable so as to surround a bundle of electric wires, and that can maintain a state of surrounding the bundle of the plurality of electric wires; and an elastic deformation portion that is provided at a portion, extending along the bundling main body portion, that can come in contact with the bundle of electric wires in a state where at least the bundling main body portion surrounds the bundle.

### TECHNICAL FIELD

The present invention relates to a technique for bundling a plurality of electric wires.

### BACKGROUND ART

Patent Document 1 discloses a technique for bundling wire harnesses with an adhesive tape.

### CITATION LIST

### Patent Documents

Patent Document 1: JP H9-115339A

### SUMMARY OF INVENTION

### Technical Problem

In order to bundle wire harnesses using adhesive tape, it is necessary to rotate the tape winding body around the wire harnesses while peeling the adhesive tape from the tape winding body, which is difficult to perform.

For example, in order for a machine to automatically perform a bundling operation using adhesive tape, the machine needs to rotate the tape winding body around the wire harnesses, which leads to the problem of the apparatus configuration being complicated and large.

A technique for bundling a plurality of electric wires using an electric wire bundling member that is deformable so as to surround a bundle of electric wires and that is formed of an elongated resin member that can maintain a state of surrounding the bundle of electric wires has been proposed.

However, when a plurality of electric wires are bundled by an electric wire bundling member formed of resin, there is a possibility that the bundling member will be laterally shifted when a lateral load acting along the extension direction of the electric wires is applied to the electric wire bundling member.

An object of the present invention is to make it less likely that the electric wire bundling member that bundles a plurality of electric wire bundles will shift laterally.

### Solution to Problem

In order to solve the above problem, a first aspect is an electric wire bundling member for bundling a plurality of electric wires, the electric wire bundling member includes: a bundling main body portion formed of an elongated resin member that can be deformed so as to surround a bundle of the plurality of electric wires, and that can maintain a state in which the bundle of the plurality of electric wires are surrounded; and an elastic deformation portion that is provided at a portion, extending along the bundling main body portion, that can come in contact with the bundle of the plurality of electric wires in a state where at least the bundling main body portion surrounds the bundle.

A second aspect is the electric wire bundling member according to the first aspect, wherein the bundling main body portion and the elastic deformation portion are double-molded.

A third aspect is the electric wire bundling member according to the first and second aspects, wherein the elastic deformation portion is also provided at a portion, extending along the bundling main body portion, that faces outward in a state where the bundling main body portion surrounds the bundle of the plurality of electric wires.

A fourth aspect is the electric wire bundling member according to any one of the first to third aspects, wherein a portion of the elastic deformation portion facing inward in a state where the bundling main body portion surrounds the bundle of the plurality of electric wires is formed in an uneven shape.

A wire harness according to a fifth aspect includes: a plurality of electric wires; and an electric wire bundling member according to any one of the first to fourth aspects that keeps the plurality of electric wires in a bundled state in a state where the elastic deformation portion is in contact with the bundle of the plurality of electric wires.

### Advantageous Effects of Invention

According to the first aspect, the elastic deformation portion comes in contact with the bundle of electric wires in a state where the bundling main body portion surrounds the bundle of electric wires. The elastic deformation portion comes in contact with the circumferential surface of the bundle of electric wires and deforms according to the surface shape of the bundle. For this reason, the contact area between the electric wire bundling member and the bundle of electric wires can be increased as much as possible. As a result, the electric wire bundling member that bundles a plurality of electric wire bundles is less likely to be laterally shifted.

According to the second aspect, because the bundling main body portion and the elastic deformation portion are double-molded, both are favorably integrated and unlikely to separate.

According to the third aspect, it is possible to suppress abnormal noise due to contact between the electric wire bundling member and the peripheral components.

According to the fourth aspect, it is easy to bring the elastic deformation portion in contact with the bundle of electric wires with a larger contact area.

According to the fifth aspect, the electric wire bundling member keeps the plurality of electric wires in a bundled state in a state where the elastic deformation portion is in contact with the bundle of electric wires. For this reason, the location bundled by the electric wire bundling portion is unlikely to shift laterally with respect to the plurality of electric wires.

### BRIEF DESCRIPTION OF DRAWINGS

FIG. 1 is a schematic view showing the overall configuration of a wire harness.

FIG. 2 is a partial side view of the wire harness.

FIG. 3 is a partial plan view of the wire harness.

FIG. 4 is a schematic cross-sectional view taken along line IV-IV in FIG. 2.

FIG. 5 is an explanatory view showing an operation example of bundling a plurality of electric wires using an electric wire bundling member.

FIG. 6 is an explanatory view showing an example of manufacturing the electric wire bundling member through double molding.

FIG. 7 is a diagram showing an electric wire bundling member according to a modification.

FIG. 8 is a diagram showing an electric wire bundling member according to another modification.

FIG. 9 is an explanatory view showing an example of a method for manufacturing the electric wire bundling member according to the other modification.

### DESCRIPTION OF EMBODIMENTS

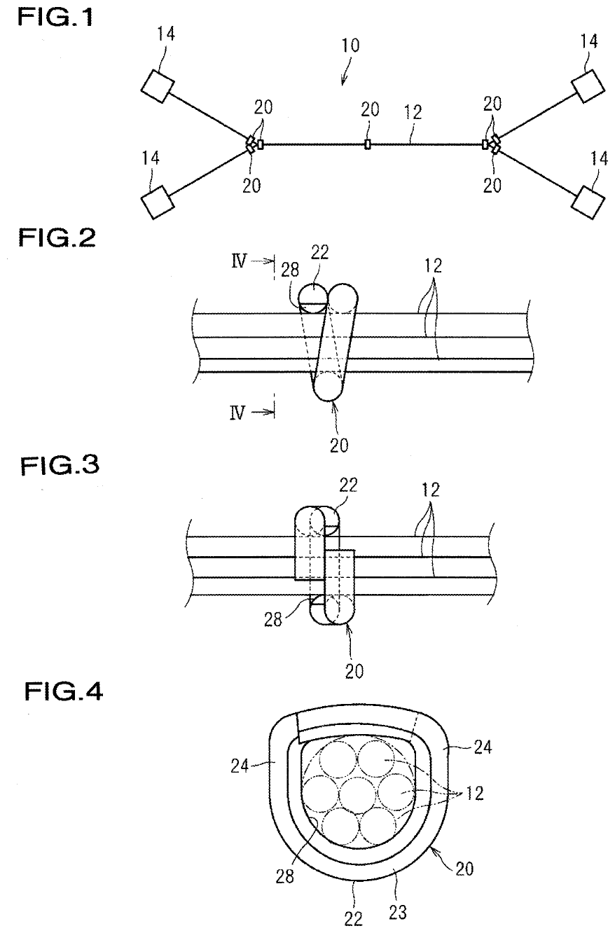

Hereinafter, an electric wire bundling member and a wire harness according to an embodiment will be described. FIG. 1 is a schematic view showing the overall configuration of a wire harness 10, FIG. 2 is a partial side view of the wire harness 10, FIG. 3 is a partial plan view of the wire harness 10, and FIG. 4 is a schematic cross-sectional view taken along line IV-IV in FIG. 2.

The wire harness 10 includes a plurality of electric wires 12 and an electric wire bundling member 20. In FIG. 1, the electric wire 12 drawn with one line is actually a bundle of electric wires 12.

The plurality of electric wires 12 are connected and integrated through a plurality of connectors 14. More specifically, the wire harness 10 is configured such that the plurality of electric wires 12 are bundled, while being branched. Then, at each branch destination of the plurality of electric wires 12, the terminal at the end of the electric wires 12 is inserted and connected to the connector 14. The plurality of electric wires 12 are bundled by the electric wire bundling members 20 so that each location is kept in the stat of a single bundle. Note that it is not essential that the plurality of electric wires 12 are branched and bundled. The plurality of electric wires 12 may also be bundled using adhesive tape, a bundling band, or the like at locations other than locations where the plurality of electric wires 12 are bundled by the electric wire bundling member 20. In a state where the wire harness 10 is incorporated in a vehicle, the connectors 14 are respectively connected to various electric components mounted on the vehicle. With this configuration, the wire harness 10 electrically connects various electric components mounted on the vehicle. Note that the wire harness 10 may also be attached using a clamp member, a protector, or the like for fixing a member to the vehicle as necessary.

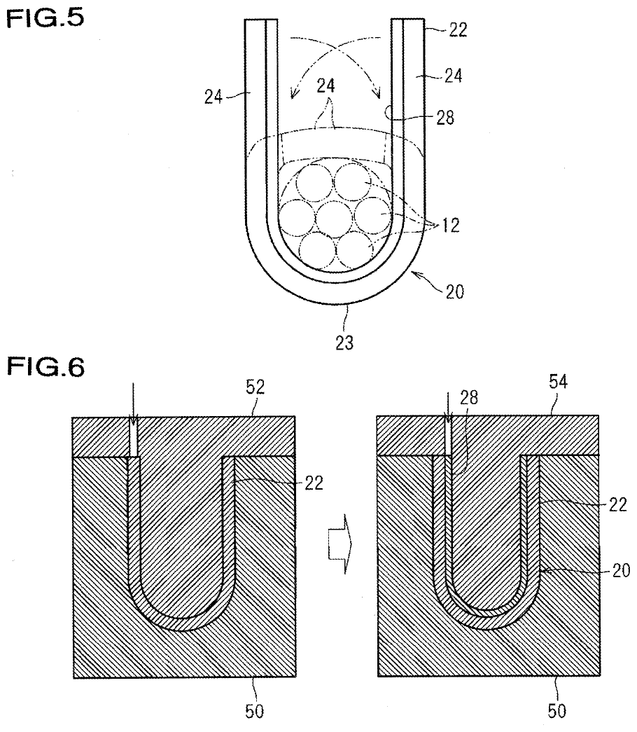

FIG. 5 is an explanatory view showing an operation example of bundling the plurality of electric wires 12 using the electric wire bundling member 20.

As shown in FIGS. 1 to 5, the electric wire bundling member 20 is a member for bundling the plurality of electric wires 12. The electric wire bundling member 20 includes a bundling main body portion 22 and an elastic deformation portion 28.

The bundling main body portion 22 is formed of an elongated resin member that can be deformed so as to surround a bundle of electric wires 12, and can maintain a state in which the bundle of electric wires 12 are surrounded.

Here, the bundling main body portion 22 is formed in a shape in which a pair of side portions 24 extend in a parallel posture from two end portions of a bottom portion 23, that is, an elongated shape having a U-shape. Here, the bottom portion 23 is formed in an arc shape, and the pair of side portions 24 rise from the two ends of the bottom portion 23 while being curved. However, the bottom portion may be formed in a straight line, and the pair of side portions may also rise from the two ends of the bottom portion at an angle such as a right angle. The distance between the pair of side portions 24 is preferably the same as the outer dimension of the bundle of electric wires 12 to be bundled. However, because the pair of side portions 24 can be deformed so as to change the distance therebetween, the distance between the pair of side portions 24 may be larger or smaller (somewhat smaller) than the outer dimension of the bundle of electric wires 12 to be bundled.

The bundling main body portion 22 is formed of a resin member, the member being made of polycarbonate etc., that can be plastically deformed by applying a force that causes deformation so as to exceed an elastic deformation range, and that can maintain the plastic deformation state to the extent that the bundling main body portion 22 can maintain a state where the bundle of electric wires 12 are surrounded.

The elastic deformation portion 28 is formed at a portion, extending along the bundling main body portion 22, that can come in contact with the bundle of electric wires 12 in a state where at least the bundling main body portion 22 surrounds the bundle. Here, the elastic deformation portion 28 is formed over the entire extension direction of the inner circumferential side portion of the bundling main body portion 22.

Here, the electric wire bundling member 20 is formed in a shape obtained by bending a round bar, and the elastic deformation portion 28 is formed at a portion occupying a part on the inner circumferential side thereof. The bundling main body portion 22 occupies a larger volume than the elastic deformation portion 28.

The elastic deformation portion 28 is made of a material that is easier to elastically deform than the bundling main body portion 22. The elastic deformation portion 28 is made of a rubber such as ethylene propylene diene rubber (EPDM), for example.

The elastic deformation portion 28 is easier to elastically deform than the bundling main body portion 22, and thus the elastic deformation portion 28 is elastically deformed following the outer circumferential shape of the electric wires 12 in a state where the electric wire bundling member 20 bundles the bundle of electric wires 12. For this reason, the contact area when the elastic deformation portion 28 is in contact with the outer circumferential surface of the electric wires 12 is larger than the contact area when the bundling main body portion 22 is in contact with the outer circumferential surface of the electric wires 12. As a result, the coefficient of friction between the electric wire bundling member 20 and the electric wires 12 is increased, and the electric wire bundling member 20 is less likely to slide on the bundle of electric wires 12.

The bundling main body portion 22 and the elastic deformation portion 28 can be formed through, for example, double molding (sometimes referred to as “two-color molding”).

In double molding, one of two parts is molded first, and the part molded first is left in one of the metal molds. Then, the one metal mold is combined with another metal mold, and the other part is molded.

Here, for example, as shown in FIG. 6, in a state where a first metal mold 50 and a second metal mold 52 are combined, resin in a fluidized state for forming the bundling main body portion 22 is injected into a molding space formed between the two metal molds 50 and 52 to mold the bundling main body portion 22. Thereafter, the second metal mold 52 is removed, and the bundling main body portion 22 remains in the first metal mold 50. Subsequently, the first metal mold 50 and a third metal mold 54 are combined, and rubber in a fluidized state for forming the elastic deformation portion 28 is injected into a molding space formed between the bundling main body portion 22 in the first metal mold 50 and the third metal mold 54 to mold the elastic deformation portion 28. At this time, because the bundling main body portion 22 and the elastic deformation portion 28 are heat-sealed favorably, they are unlikely to separate. Thereafter, the first metal mold 50 is removed from the third metal mold 54, and the electric wire bundling member 20 is taken out, whereby the electric wire bundling member 20 can be manufactured.

In the above example, the elastic deformation portion 28 is molded after the bundling main body portion 22 is molded. However, conversely, the bundling main body portion 22 may also be molded after the elastic deformation portion 28 is molded.

Further, it is not essential that the electric wire bundling member 20 is formed through double molding. The electric wire bundling member 20 may also be formed, for example, through insert-molding using one of the bundling main body portion 22 and the elastic deformation portion 28 as an insert part. Also, the electric wire bundling member 20 may also be configured such that the bundling main body portion 22 and the elastic deformation portion 28 are combined by a fitting structure, an adhesive, or the like after both have been separately molded.

The plurality of electric wires 12 can be bundled by the electric wire bundling member 20 by disposing the bundle of electric wires 12 in a space surrounded by the bottom portion 23 and the pair of side portions 24 in the electric wire bundling member 20, and applying a force that deforms the distal ends of the pair of side portions 24 toward each other so as to surround the bundle of electric wires 12. In particular, because the pair of side portions 24 extends in parallel in the same direction with respect to the bottom portion 23, the bundle of electric wires 12 can be easily disposed in the electric wire bundling member 20. Further, because the pair of side portions 24 are formed to be bent with respect to the bottom portion 23, it is not necessary to perform an operation of bending the electric wire bundling member 20 on sides in three of four directions of the bundle of electric wires 12. In bending the pair of side portions 24, it is preferable to locally bend the intermediate portion in the extension direction of the pair of side portions. In this manner, the pair of side portions 24 can be easily deformed exceeding the elastic deformation range.

The deformation of the electric wire bundling member 20 may also be performed by an operator using a crimping tool or the like, or may also be performed by an operator using a dedicated device for deforming the electric wire bundling member 20. As a device for deforming the electric wire bundling member 20, a device, to which a known configuration is applied, used as a bag bundling device for closing an opening of a bag containing food can be used.

According to the electric wire bundling member 20 and the wire harness 10 configured as described above, the elastic deformation portion 28 comes in contact with the bundle of electric wires 12 in a state where the bundling main body portion 22 surrounds the bundle of electric wires 12. The elastic deformation portion 28 comes in contact with the bundle of electric wires 12 and deforms according to the surface shape of the bundle. For this reason, the contact area between the electric wire bundling member 20 and the bundle of electric wires 12 can be increased as much as possible. As a result, it becomes less likely that the electric wire bundling member 20 that bundles the bundle of electric wires 12 will laterally shift.

In particular, the wire harness 10 bundled by the electric wire bundling member 20 has the advantage that the bundling locations and the branch locations are unlikely to shift, and a certain form can be easily maintained.

Also, by deforming the electric wire bundling member 20 so as to surround the plurality of electric wires 12, the state in which the electric wire bundling member 20 surrounds the bundle of electric wires 12 can be maintained. For this reason, the bundling operation performed on the plurality of electric wires 12 can be easily performed without performing the operation of rotating the tape winding body around the electric wires while peeling off the adhesive tape from the tape winding body as in prior art. As a result, simplification and downsizing of the device for bundling work can be easily realized.

Further, because the plurality of electric wires 12 are bundled by the electric wire bundling member 20 that is a combination of a resin member and an elastic member, the electric wires 12 are unlikely to be damaged.

Also, because the electric wire bundling member 20 has a simple shape, the electric wire bundling member 20 contributes to cost reduction.

In addition, because the bundling main body portion 22 and the elastic deformation portion 28 are double-molded, they are favorably integrated and unlikely to separate.

### Modifications

Various modifications will be described based on the above embodiment.

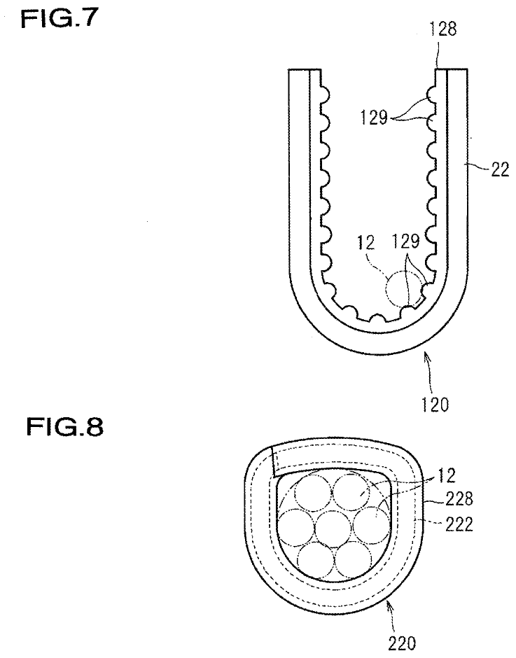

First, like an electric wire bundling member 120 shown in FIG. 7, of an elastic deformation portion 128 corresponding to the elastic deformation portion 28, a portion facing inward in a state where the bundling main body portion 22 surrounds a bundle of electric wires 12 may also be formed in an uneven shape. Here, a plurality of protruding portions 129 are formed on the inner side portion of the elastic deformation portion 128 at intervals along the extension direction of the bundling main body portion 22. Each protruding portion 129 is formed in a partial spherical shape or a semi-cylindrical shape extending in a direction orthogonal to the extension direction of the bundling main body portion 22. A recessed portion is formed between the protruding portions 129. The recessed portion is observed as a recession when observed in the direction orthogonal to the extension direction of the bundling main body portion 22, that is, along the extension direction of the electric wires 12 in a state where the bundle of electric wires 12 are bundled. With this configuration, an electric wire 12 can be partially disposed in each recessed portion. Each protruding portion 129 may also have a prismatic or pyramidal protrusion shape.

When a bundle of electric wires 12 are bundled by the electric wire bundling member 120, each protruding portion 129 is deformed according to the outer shape of the electric wires 12 while an electric wire 12 enters between the protruding portions 129. For this reason, the contact area between the elastic deformation portion 128 and the bundle of electric wires 12 can be further increased. As a result, the electric wire bundling member 20 is even less likely to be laterally shifted.

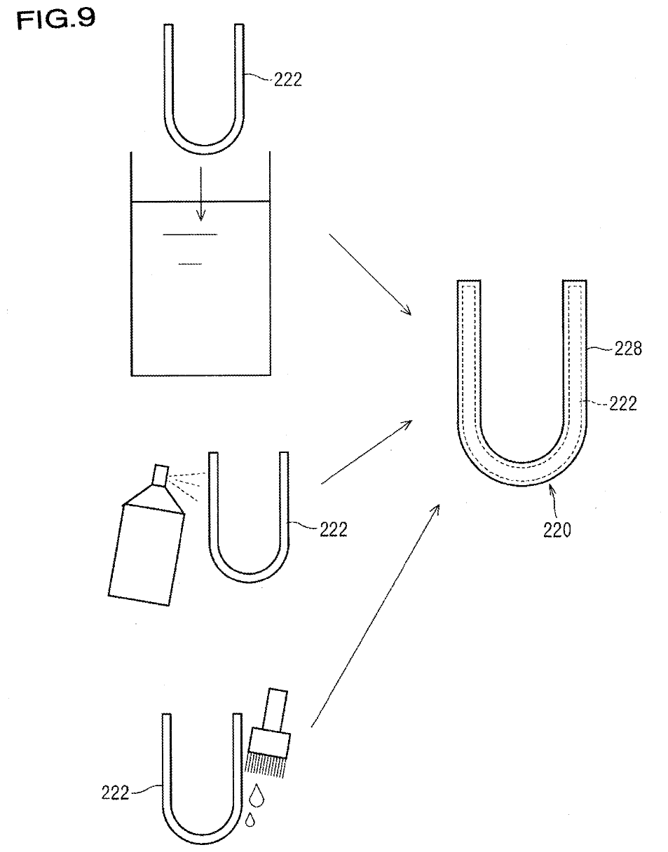

An electric wire bundling member 220 shown in FIG. 8 is provided with an elastic deformation portion 228 at a portion facing inward and outward in a state where a bundling main body portion 22 surrounds the bundle of electric wires 12 around the bundling main body portion 222 corresponding to the bundling main body portion 22.

More specifically, the bundling main body portion 222 is formed in a U-shape similarly to the bundling main body portion 22.

The elastic deformation portion 228 is formed so as to cover the entire circumference of the bundling main body portion 222. Because the elastic deformation portion 228 covers the entire circumference of the bundling main body portion 222, the elastic deformation portion 128 is provided at a portion facing inward and a portion facing outward in a state where the bundling main body portion 222 surrounds the bundle of electric wires 12.

As shown in FIG. 9, for example, the elastic deformation portion 228 mentioned above can be formed by immersing the bundling main body portion 22 in a liquid in which a material for forming the elastic deformation portion 228 is dissolved and adhering the liquid to the surface thereof, and then solidifying the liquid, by spraying or the like a liquid in which a material for forming the elastic deformation portion 228 is dissolved and adhering the liquid to the surface of the bundling main body portion 22, and then solidifying the liquid, or by applying a liquid in which a material for forming the elastic deformation portion 228 to the surface of the bundling main body portion 22 using a brush or the like.

In such an electric wire bundling member 220, the elastic deformation portion 228 is provided at an outward facing portion in the state where the electric wire bundling member 220 bundles the bundle of electric wires 12. As a result, in the state where the wire harness 10 is incorporated in a vehicle or the like, abnormal noise between the electric wire bundling member 220 and peripheral components can be suppressed.

Note that the configurations that have been described in the foregoing embodiment and modifications can be combined as appropriate unless they are inconsistent with one another. As shown in FIG. 9, for example, even when the elastic deformation portion is formed through immersion, spraying, or application, it is possible to form the elastic deformation portion only on the inner circumferential portion of the bundling main body portion, by masking the outer circumferential portion of the bundling main body portion.

As described above, the present invention has been described in detail, but the above description is illustrative in all aspects, and the present invention is not limited thereto. It is understood that countless modifications that are not illustrated can be envisaged without departing from the scope of the present invention.

### LIST OF REFERENCE NUMERALS

10 Wire harness
12 Electric wire
20, 120, 220 Electric wire bundling member
22, 222 Bundling main body portion
28, 128, 228 Elastic deformation portion
129 Protruding portion
220 Electric wire bundling member
222 Bundling main body portion

1. An electric wire bundling member for bundling a plurality of electric wires, comprising:
a bundling main body portion formed of an elongated resin member that can be deformed so as to surround a bundle of the plurality of electric wires, that can be plastically deformed by applying a force that causes deformation so as to exceed an elastic deformation range, and that can maintain the plastic deformation state to the extent that the state in which the bundle of electric wires are surrounded can be maintained; and
an elastic deformation portion that is provided at a portion, extending along the bundling main body portion, that can come in contact with the bundle of the plurality of electric wires in a state where at least the bundling main body portion surrounds the bundle.

2. The electric wire bundling member according to claim 1,
wherein the bundling main body portion and the elastic deformation portion are double-molded.

3. The electric wire bundling member according to claim 1,
wherein the elastic deformation portion is also provided at a portion, extending along the bundling main body portion, that faces outward in a state where the bundling main body portion surrounds the bundle of the plurality of electric wires.

4. The electric wire bundling member according to claim 1,
wherein a portion of the elastic deformation portion facing inward in a state where the bundling main body portion surrounds the bundle of the plurality of electric wires is formed in an uneven shape.

5. A wire harness comprising:
a plurality of electric wires; and
the electric wire bundling member according to claim 1 that keeps the plurality of electric wires in a bundled state in a state where the elastic deformation portion is in contact with the bundle of the plurality of electric wires,
wherein the bundling main body portion is formed in a shape in which a pair of side portions extend in a parallel posture from two end portions of its bottom portion, and is plastically deformed in such a manner that an intermediate portion in the extension direction of the pair of side portions is locally bent and distal end portions of the pair of side portions approach each other.

6. An electric wire bundling member for bundling a plurality of electric wires, comprising:
a bundling main body portion formed of an elongated resin member that can be deformed so as to surround a bundle of the plurality of electric wires and that can maintain a state in which the bundle of the plurality of electric wires are surrounded; and
an elastic deformation portion that is provided at a portion, extending along the bundling main body portion, that can come in contact with the bundle of the plurality of electric wires in a state where at least the bundling main body portion surrounds the bundle,
wherein the elastic deformation portion is also provided at a portion, extending along the bundling main portion, that faces outward on the side opposite to the bundle of electric wires in a state where the bundling main body portion surrounds the bundle of the plurality of electric wires.
